(19) United States
(12) Patent Application Publication
(10) Pub. No.: US 2020/0280699 A1
(43) Pub. Date: Sep. 3, 2020

(54) DISPLAY DEVICE, IMAGING AND DISPLAY SYSTEM, AND TRAIN

(71) Applicant: SHARP KABUSHIKI KAISHA, Sakai City, Osaka (JP)

(72) Inventors: KEISUKE OMORI, Sakai City, Osaka (JP); KEI TOKUI, Sakai City, Osaka (JP)

(21) Appl. No.: 16/764,235

(22) PCT Filed: Nov. 16, 2018
(86) PCT No.: PCT/JP2018/042404

§ 371 Date: May 14, 2020

(30) Foreign Application Priority Data
Nov. 21, 2017 (JP) 2017-223817

(51) Int. Cl. H04N 7/18; H04N 5/225; H04N 5/247; B61K 13/00; B61B 1/02

(52) U.S. Cl. CPC H04N 7/181; H04N 5/2253; B61B 1/02; B61K 13/00; H04N 5/247

(57) ABSTRACT

A display device is installed on a train including a plurality of carriages on at least one of which at least one imaging device is installed. The display device includes: one or more processors configured to cause the display device to function as an image processing circuitry, the image processing circuitry being configured to generate a display image based on at least one image captured by the imaging device and on relative positions of the carriage on which the imaging device is installed and a carriage on which the display device is installed; and a display configured to display the display image generated by the image processing circuitry.

### TECHNICAL FIELD

The present invention relates to display devices, imaging and display systems, and trains.

The present application claims the benefit of priority to Japanese Patent Application, Tokugan, No. 2017-223817 filed on Nov. 21, 2017, the entire contents of which are incorporated herein by reference.

### BACKGROUND ART

Conventional display technology includes at least one video-capturing camera installed on a station platform (hereinafter may be referred to as “platform”) and display devices for displaying a captured video, so that the train driver, conductor, and station staff can watch the displayed video to check and ensure safety on the station platform. Two or more cameras may be installed at places where the cameras will be free from blind areas if the railway staff cannot find a long line-of-sight, particularly if the train consists (primarily) of many carriages or the station platform is situated on a curved track. The technology is very useful because it enables the train driver, conductor, and station staff to monitor the entire station platform without having to walking up and down the platform. Video-based safety monitoring is also useful in reducing manpower in checking and ensuring safety on station platforms.

Patent Literature 1 describes an example of such platform safety monitoring technology where a safety monitoring device displays multiple videos captured by a plurality of cameras on a single monitor in the conductor's cabin.

### CITATION LIST

### Patent Literature

Patent Literature 1: Japanese Unexamined Patent Application Publication, Tokukaihei, No. 9-93565 (Publication Date: Apr. 4, 1997)

### SUMMARY OF INVENTION

### Technical Problem

The safety monitoring device described in Patent Literature 1, however, is built without paying attention to the relationship between the imaging direction of a camera and that of another or the relationship between the imaging directions of the cameras and the location of the person who checks the videos and also without paying attention to how the videos should be arranged on a single monitor. A display may be produced in which it is difficult to recognize the relative positions of the carriages and the subject on the platform, depending on the imaging directions of the cameras and the layout of the images on a single monitor.

The present invention, in an aspect thereof, has an object to produce a display of a train and a vicinity thereof in a manner suitable for monitoring.

### Solution to Problem

To address these issues, the present invention, in an aspect thereof, is directed to a display device installed on a train including a plurality of carriages on at least one of which an imaging device is installed, the display device including: an image processing unit configured to generate a display image based on an image captured by the imaging device and on relative positions of the carriage on which the imaging device is installed and a carriage on which the display device is installed; and a display unit configured to display the display image generated by the image processing unit.

### Advantageous Effects of Invention

The present invention, in an aspect thereof, can produce a display of a train and a vicinity thereof in a manner suitable for monitoring.

### BRIEF DESCRIPTION OF DRAWINGS

Portion (a) of FIG. 1 is a block diagram of a configuration of major components of a display system installed in a train in accordance with Embodiment 1 of the present invention, (b) of FIG. 1 is a side view of the train in accordance with Embodiment 1 of the present invention, and (c) of FIG. 1 is a plan view of the train in accordance with Embodiment 1 of the present invention.

FIG. 2 is a set of plan views of the train in accordance with Embodiment 1 of the present invention.

FIG. 3 is an illustration of exemplary displays of camera-captured images arranged next to each other in accordance with Embodiment 1 of the present invention.

FIG. 4 is an illustration of exemplary displays of camera-captured images arranged next to each other in accordance with Embodiment 1 of the present invention.

FIG. 5 is an illustration of an exemplary display of camera-captured images arranged next to each other in accordance with Embodiment 1 of the present invention.

FIG. 6 is an illustration of a display screen of a display device in accordance with Embodiment 1 of the present invention.

Portion (a) of FIG. 7 is a side view of a carriage in accordance with Embodiment 2 of the present invention, and (b) of FIG. 7 is a plan view of the carriage in accordance with Embodiment 2 of the present invention.

FIG. 8 is a plan view of a train in accordance with Embodiment 2 of the present invention.

FIG. 9 is a plan view of a portion of a train in accordance with Embodiment 2 of the present invention.

FIG. 10 is a set of side views of a train in accordance with Embodiment 3 of the present invention.

FIG. 11 is an illustration of a display screen of a display device in accordance with Embodiment 4 of the present invention.

Portion (a) of FIG. 12 is an illustration of display images for monitoring the left side of carriages of a train in accordance with Embodiment 4 of the present invention when the train is moving to the right in the figure, and (b) of FIG. 12 is an illustration of display images for monitoring the right side of the carriages of a train in accordance with Embodiment 4 of the present invention when the train is moving to the right in the figure.

FIG. 13 is an illustration of an overhead view of a train and camera-captured images being displayed on a display screen in accordance with Embodiment 4 of the present invention.

FIG. 14 is an illustration of an overhead view of a train and camera-captured images being displayed on a display screen in accordance with Embodiment 5 of the present invention.

FIG. 15 is an illustration of an overhead view of a train and camera-captured images being displayed on a display screen in accordance with Embodiment 6 of the present invention.

FIG. 16 is an illustration of an overhead view of a train and camera-captured images being displayed on a display screen in accordance with Embodiment 6 of the present invention.

### DESCRIPTION OF EMBODIMENTS

### Embodiment 1

The following will describe in detail a display device 1 in accordance with Embodiment 1 of the present invention with reference to FIGS. 1 to 6.

Portion (a) of FIG. 1 is a block diagram of a configuration of major components of a display system (imaging and display system) 50 installed in a train 100 in accordance with the present embodiment. The display system 50 installed in the train 100 primarily includes display devices 1 and cameras (imaging devices) 106 to 117 (portion (a) of FIG. 1 shows the camera 106 alone and none of the other cameras). Each display device 1, installed in the train 100, is connected to the cameras 106 to 117 via wired or wireless communication, to acquire images captured by the cameras 106 to 117 for display. The cameras 106 to 117 are installed on at least some of the carriages making up the train 100 to capture images of the exterior of the carriages.

The display device 1 includes an image processing unit 11 and a display unit 12. The image processing unit 11 generates display images from images captured by the cameras 106 to 117 on the basis of the relative positions of the carriages where the cameras 106 to 117 are installed and the carriages where the display device 1 is installed. The display unit 12 displays the display images generated by the image processing unit 11.

Portion (b) of FIG. 1 is a side view of the train 100 in accordance with the present embodiment as the train 100 is viewed from a side thereof. Portion (c) of FIG. 1 is a plan view of the train 100 in accordance with the present embodiment as the train 100 is viewed from above.

The train 100 consists (primarily) of a set of coupled carriages 101, 102, and 103. The carriage 101 has a driver's cab 104, and the carriage 103 has a driver's cab 105. The carriage 101 has the cameras 106, 107, 112, and 113, the carriage 102 has the cameras 108, 109, 114, and 115, and the carriage 103 has the cameras 110, 111, 116, and 117. The cameras 106 to 117 are all located substantially along a straight line on the sides of the carriages. In an aspect of the invention, there is no need to provide a camera on every carriage, It is only required that a camera be provided on at least one of the carriages.

The display device 1 is installed each driver's cab 104 and 105.

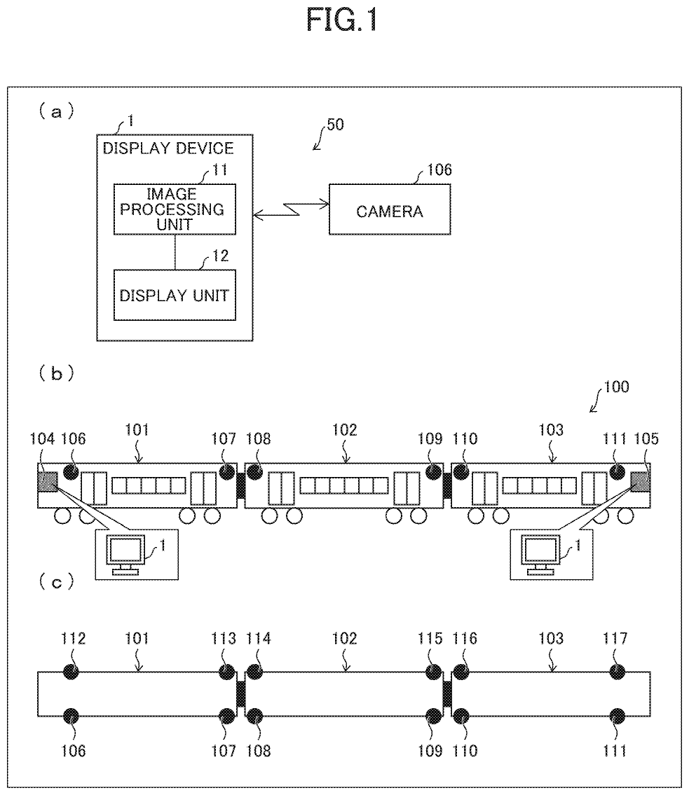

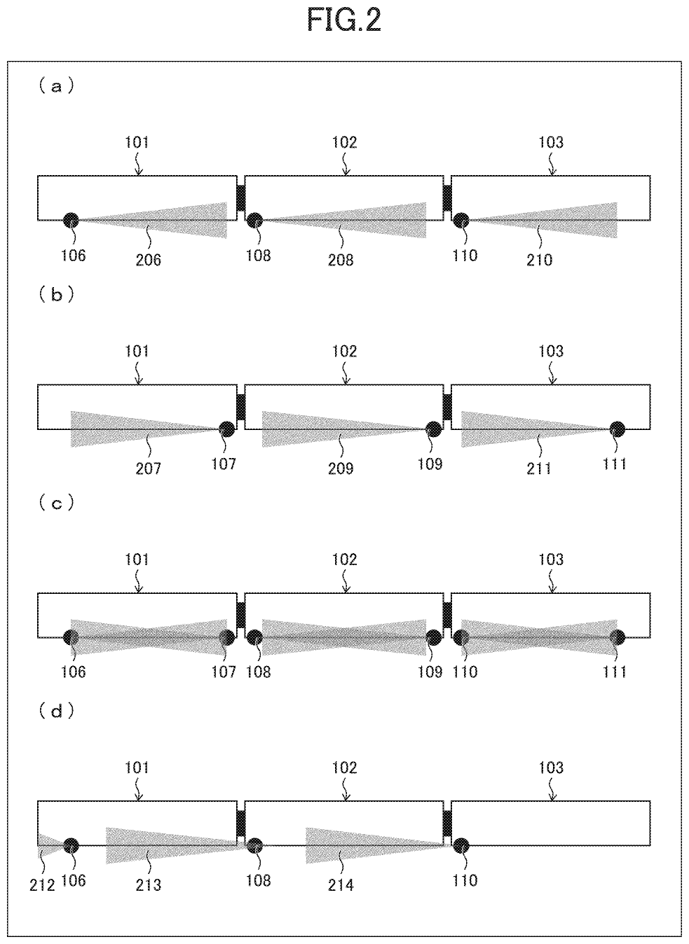

Portions (a), (b), (c), and (d) of FIG. 2 are plan views of the train 100 in accordance with the present embodiment as the train 100 is viewed from above. Portion (a) of FIG. 2 illustrates an imaging range 206 of the camera 106 installed on a side of the carriage 101, an imaging range 208 of the camera 108 installed on a side of the carriage 102, and an imaging range 210 of the camera 110 installed on a side of the carriage 103. The cameras 106, 108, and 110 are provided so as to respectively capture images of the sides of the carriages, for the purpose of monitoring a station platform. The cameras 106, 108, and 110 are pointed in the same direction.

Portion (b) of FIG. 2 illustrates an imaging range 207 of the camera 107 installed on a side of the carriage 101, an imaging range 209 of the camera 109 installed on a side of the carriage 102, and an imaging range 211 of the camera 111 installed on a side of the carriage 103. The cameras 107, 109, and 111 are provided so as to respectively capture images of the sides of the carriages, for the purpose of monitoring a station platform. The cameras 107, 109, and 111 are pointed in the same direction.

Portion (c) of FIG. 2 shows the imaging ranges 206, 208, and 210 in (a) of FIG. 2 superimposed over the imaging ranges 207, 209, and 211 in (b) of FIG. 2. The cameras 106, 108, and 110 are pointed in the opposite direction from the cameras 107, 109, and 111 as shown in (c) of FIG. 2. The imaging range 206 partially overlaps the imaging range 207, the imaging range 208 partially overlaps the imaging range 209, and the imaging range 210 partially overlaps the imaging range 211.

Assuming that the train 100 is moving to the right in (c) of FIG. 2 (which is the forward direction), the cameras 106, 108, and 110 have imaging ranges covering the forward direction with respect to the train 100, and the cameras 107, 109, and 111 have imaging ranges covering the backward direction with respect to the train 100.

In accordance with this, if there is a camera installed in a carriage located forward of the carriage where the display device 1 under consideration is installed, the image processing unit 11 selects an image captured by the camera having an imaging range covering the forward direction (i.e., an image having such an angle of view as to cover the forward direction with respect to the train 100) from those images captured by the camera installed in the carriage located forward. if there is a camera installed in a carriage located backward of the carriage where the display device 1 under consideration is installed, the image processing unit 11 selects an image captured by the camera having an imaging range covering the backward direction (i.e., an image having such an angle of view as to cover the backward direction with respect to the train 100) from those images captured by the camera installed in the carriage located backward. The image processing unit 11 then generates a display image from the selected image.

Portion (d) of FIG. 2 shows that the cameras 106, 108, and 110 in (a) of FIG. 2 are capable of imaging the backward direction as well as the forward direction. The cameras 106, 108, and 110, in (a) and (d) of FIG. 2, allow for imaging range control.

In accordance with this, if there is a camera installed in a carriage located forward of the carriage where the display device 1 under consideration is installed, the image processing unit 11 controls the camera installed in the carriage located forward in such a manner that the imaging range of the camera covers the forward direction with respect to the train 100. If there is a camera installed in a carriage located backward of the carriage where the display device 1 under consideration is installed, the image processing unit 11 controls the camera installed in the carriage located backward in such a manner that the imaging range of the camera covers the backward direction with respect to the train 100. The image processing unit 11 then generates a display image from the image captured by the camera thus controlled.

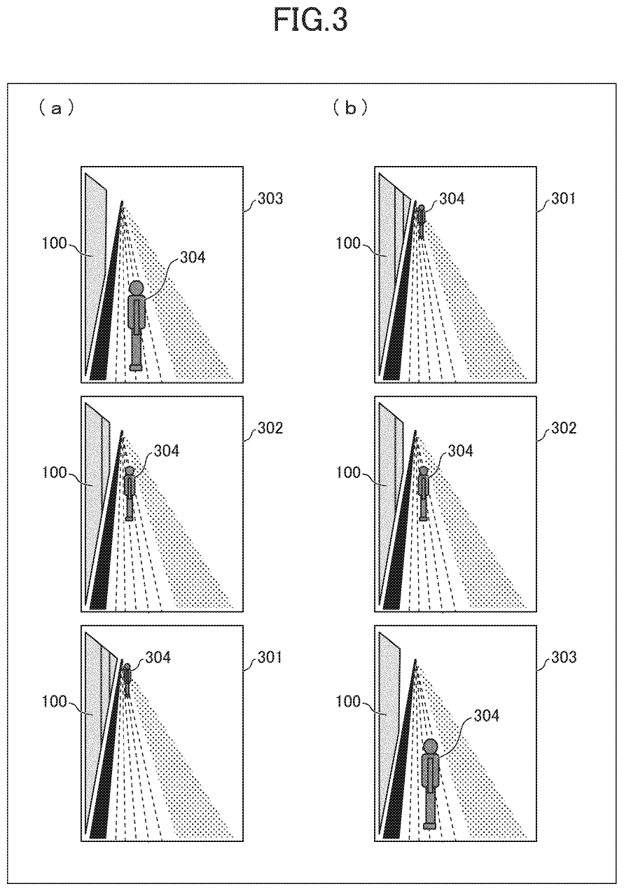

FIG. 3 is an illustration of exemplary displays of camera-captured images arranged next to each other in accordance with Embodiment 1 of the present invention. When the display image is to include a plurality of images, the image processing unit 11 arranges the images in such a manner that the carriages where the cameras capturing the images are installed appear lined up along a specific direction in the approaching order when viewed from the carriage where the display device 1 is installed. The specific direction is parallel to the direction from the distant view to the near view in each image. These specifics are applied to both cases where each camera has an imaging range covering the forward direction with respect to the train 100 or the backward direction with respect to the train 100 and cases where each camera allows for imaging range control.

Portion (a) of FIG. 3 illustrates an exemplary display in accordance with the present embodiment where an image 301 captured by the camera 106, an image 302 captured by the camera 108, and an image 303 captured by the camera 110 are arranged next to each other. Each image shows the train 100 in the left and a station platform in the right. Each image further shows a passenger 304 standing on the platform. The cameras 106, 108, and 110 are pointed in the same direction. Each captured image 301, 302, and 303 shows a near view in the bottom thereof and a distant view in the top thereof. All the captured images 301, 302, and 303 hence share the same near-view-to-distant-view direction. As shown in (a) of FIG. 2, the camera 106 is pointed in the direction of the cameras 108 and 110, and the camera 108 is pointed in the direction of the camera 110.

Therefore, the captured images 301, 302, and 303, when arranged in the order shown in (a) of FIG. 3, show the distant view in each of the three captured images contiguously to the near view in a next one of the three captured images. The display device 1 can thus display captured images covering the length of the train 100 along the moving direction of the train 100, so that one can easily recognize the relative positions and directions represented by the images. The produced display is suitable for the monitoring of the station platform by the user.

Meanwhile, similarly to (a) of FIG. 3, (b) of FIG. 3 illustrates an exemplary display in accordance with the present embodiment where the image 301 captured by the camera 106, the image 302 captured by the camera 108, and the image 303 captured by the camera 110 are arranged next to each other. A difference lies where the captured image 301 and the captured image 303 are transposed in the display shown in (b) of FIG. 3 from (a) of FIG. 3. In the display order shown in (b) of FIG. 3, the display device 1 displays the images captured by the camera 108 and the camera 110, which are disposed away from the camera 106, below the image 301 captured by the camera 106. In other words, the display device 1 displays the captured images 302 and 303, which are distant view images for the camera 106, next to the near view side of the captured image 301.

This arrangement does not place the distant view in each of the three captured images contiguously to the near view in a next one of the three captured images, which makes the relative positions and directions represented by the images complicated when compared with the display order shown in (a) of FIG. 3. The display order shown in (a) of FIG. 3 is hence more suitable because it is easier to recognize the relative positions and directions represented by the images in the display order shown in (a) of FIG. 3.

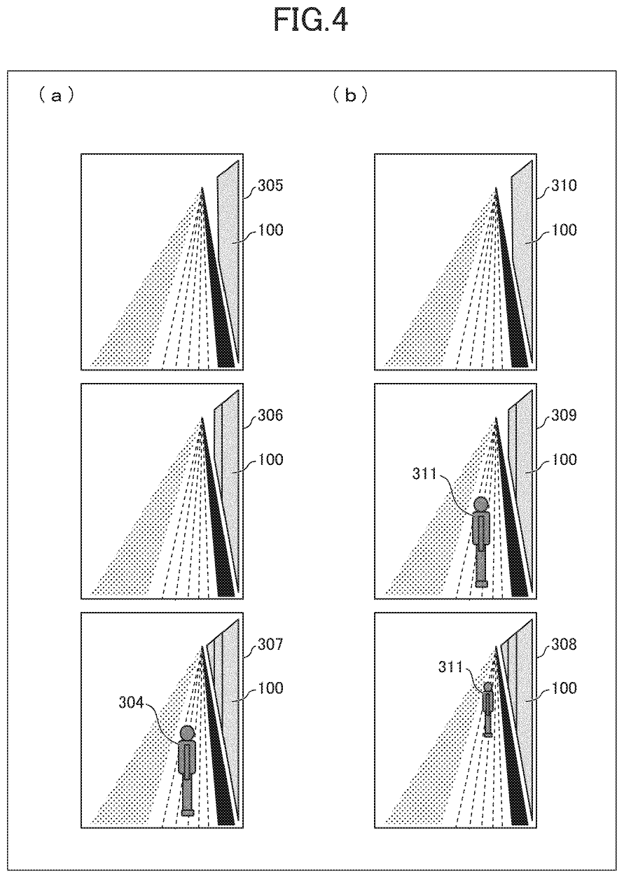

Portion (a) of FIG. 4 illustrates an exemplary display in accordance with the present embodiment where an image 305 captured by the camera 107, an image 306 captured by the camera 109, and an image 307 captured by the camera 111 are arranged next to each other. Each image shows the train 100 in the right and a station platform in the left. The captured image 307 further shows the passenger 304 standing on the platform. The cameras 107, 109, and 111 are pointed in the same direction. Each captured image 305, 306, and 307 shows a near view in the bottom thereof and a distant view in the top thereof. All the captured images 305, 306, and 307 hence share the same near-view-to-distant-view direction. As shown in (b) of FIG. 2, the camera 111 is pointed in the direction of the cameras 107 and 109, the camera 109 is pointed in the direction of the camera 107.

Therefore, the captured images 305, 306, and 307, when arranged in the order shown in (a) of FIG. 4, show the distant view in each of the three captured images contiguously to the near view in a next one of the three captured images. The display device 1 can thus display captured images covering the length of the train 100 along the direction of the train 100, so that one can easily recognize the relative positions and directions represented by the images. The produced display is suitable for the monitoring of the station platform by the user.

Accordingly, the near and distant views in the three captured images are displayed contiguously by arranging the three captured images in a proper order, regardless of whether the display device 1 is to display the images captured by the cameras 106, 108, and 110 or the images captured by the cameras 107, 109, and 111 pointed in the opposite direction from the cameras 106, 108, and 110. The display device 1 can thus display captured images covering the length of the train 100 along the moving direction of the train 100, so that one can easily recognize the relative positions and directions represented by the images. The produced display is suitable for the monitoring of the station platform by the user. A method will be described later in detail as to how to display the images captured by one of two oppositely pointing groups of cameras that is more suitable for monitoring.

Portion (b) of FIG. 4 illustrates exemplary display in accordance with the present embodiment where an image 308 captured by the camera 112, an image 309 captured by the camera 114, and an image 310 captured by the camera 116 are arranged next to each other. These captured images 308, 309, and 310 are captured on the other side of the train 100, that is, on the side where the cameras 112, 113, 114, 115, 116, and 117 shown in (c) of FIG. 1 are installed. Each image shows the train 100 in the right and a station platform in the left. The captured image 308 and the captured image 309 further show a passenger 311 standing on the platform. The cameras 112, 114, and 116 are pointed in the same direction. Each captured image 308, 309, and 310 shows a near view in the bottom thereof and a distant view in the top thereof. All the captured images 308, 309, and 310 hence share the same near-view-to-distant-view direction.

The display device 1 can thus display captured images covering the length of the train 100 along the moving direction of the train 100, so that one can easily recognize the relative positions and directions represented by the images. The produced display is suitable for the monitoring of the station platform by the user. One should monitor boarding and alighting passengers on different sides of the carriages (train), depending on stations (one should monitor passengers on the side on which the doors are opened to allow passengers to board and alight, the train). The display device 1 is however capable of displaying suitable images for monitoring by the user regardless of on which side passengers board and alight the train, by displaying the images captured by the cameras installed on the side of the train that should be monitored as shown in (a) of FIG. 3 and (b) of FIG. 4.

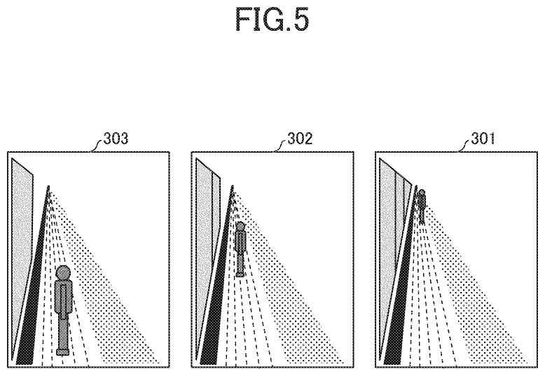

FIG. 5 illustrates an exemplary display of the captured images 301, 302, and 303 arranged in an order in accordance with the present embodiment, Each captured image 301, 302, and 303 shows a near view in the bottom thereof and a distant view in the top thereof. Note that in terms of the left-right direction, the images may be interpreted as showing a near view in the right and a distant view in the left because the images have a vanishing point (infinitely distant point in the perspective drawing) in the upper left. Therefore, the captured images 301, 302, and 303, when arranged in this order from the right to the left as shown in FIG. 5, show the distant view in each of the three captured images contiguously to the near view in a next one of the three captured images, so that one can easily recognize the relative positions and directions represented by the images. The produced display is suitable for the monitoring of the station platform by the user.

The display device 1, which displays captured images, may be installed, for example, in the driver's cab so that the train driver can monitor the platform from the inside of the carriage or in a crew's cabin used by a conductor. As another alternative, the display device 1 may be installed, for example, on a station platform or in a room located in a prescribed location in a station.

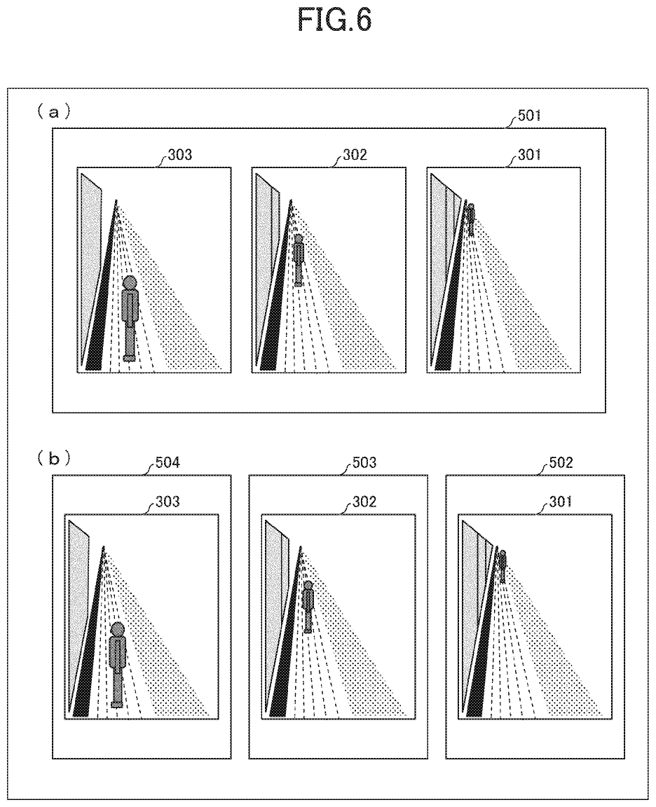

FIG. 6 illustrates the display screen of the display device 1 in accordance with the present embodiment. Referring to (a) of FIG. 6, the display device 1 may display a plurality of images next to each other on a single display screen 501. Alternatively, referring to (b) of FIG. 6, when there is provided a plurality of display screens 502, 503, and 504 next to each other, the display device 1 may display the captured image 301 on the display screen 502, the captured image 302 on the display screen 503, and the captured image 303 on the display screen 504. In other words, the images need only to be arranged such that the near and distant views in the images are displayed contiguously.

### Advantages of Embodiment 1

As described in the above, there is provided a plurality of cameras with the same imaging direction substantially along a straight line on the sides of the train 100. A plurality of images captured by the cameras is displayed such that the near and distant views in the captured images represent the same direction and that the near and distant views in the images appear contiguous. This configuration enables the images to be displayed at positions suitable for monitoring by the user.

When the train 100 is on a curved track, the cameras, installed on a plurality of carriages, are located on a curved line. The above-described advantages are achieved when the train 100 is on a curved track similarly to when the train 100 is on a straight track. The cameras therefore need only to be located on a substantially straight line when the train 100 is on a straight track.

### Embodiment 2

A detailed description will be given next of a display device 1 in accordance with Embodiment 2 of the present invention with reference to FIGS. 7 to 9. The present embodiment produces a display that is more suitable for monitoring by taking into account the location of the user (e.g., the train driver, conductor, or station staff) who checks the displayed image(s).

Portion (a) of FIG. 7 is a side view of a carriage 601 in accordance with the present embodiment. The carriage 601 has cameras 602 and 603 on a side thereof. The carriage 601, which is the front car of the train 100, has a driver's cab 604. Carriages can move in both directions. Assume in this embodiment that the carriage 601 is moving in the direction indicated by an arrow 605 in FIG. 7.

Portion (b) of FIG. 7 is a plan view of the carriage 601 in accordance with the present embodiment as the carriage 601 is viewed from above, Portion (b) of FIG. 7 shows the carriage 601 and a station platform 606. When the carriage 601 and the platform 606 are located in the relative positions shown in (b) of FIG. 7, a train driver (not shown) in the driver's cab 604 will find the platform 606 on his/her left-hand side if he/she is looking in the moving direction indicated by the arrow 605. The train driver therefore will look at the left rear to visually check the platform 606.

Referring to FIG. 7, the cameras 602 and 603 are disposed in locations where the cameras 602 and 603 can capture images of the left side of the carriage 601. The camera 602 is pointed in the backward direction with respect to the carriage 601 to capture images in an imaging range 607 shown in (b) of FIG. 7. Meanwhile, the camera 603 is pointed in the forward direction with respect to the carriage 601. The cameras 602 and 603 have an imaging range covering the platform 606. Since the train driver monitors the left rear, the imaging direction of the camera 602 matches the visual monitoring direction of the train driver. The produced display therefore appears natural to the train driver. In contrast, the imaging direction of the camera 603 is opposite to the visual monitoring direction of the train driver. The produced display therefore appears less natural to the train driver than the display produced from the image captured by the camera 602. Therefore, the image captured by the camera 602 is more suitable for the monitoring of the platform by the train driver.

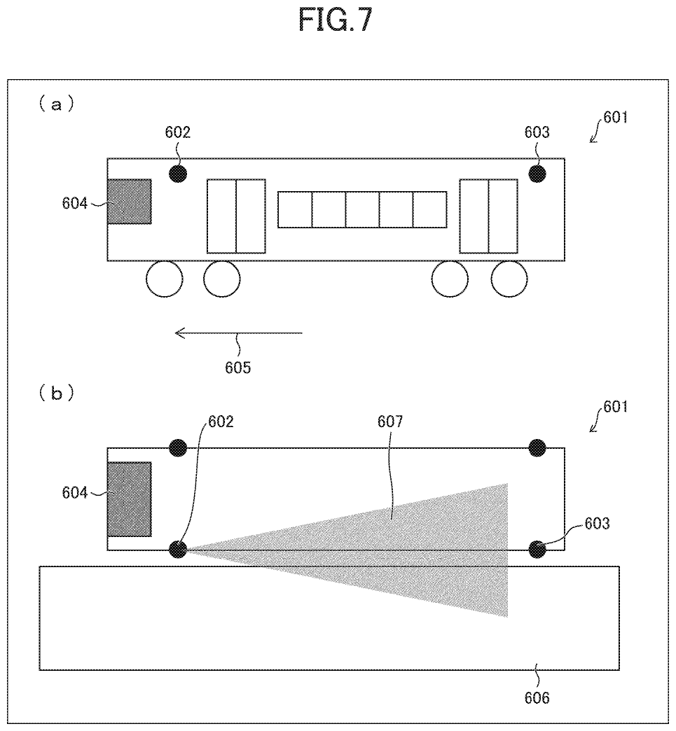

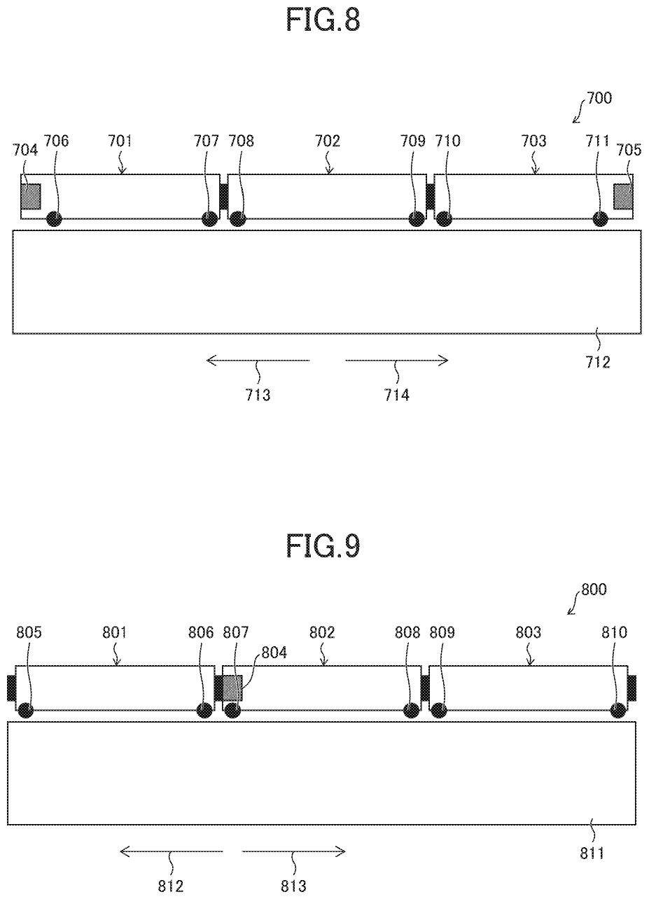

FIG. 8 is a plan view of a train 700 in accordance with the present embodiment as the train 700 is viewed from above. FIG. 8 shows the train 700 and a station platform 712. The train 700 consists (primarily) of a set of coupled carriages 701, 702, and 703. The carriage 701 has a driver's cab 704, and the carriage 703 has a driver's cab 705. Each carriage is provided with cameras. FIG. 8 shows only those cameras that are located on one of the sides of the car (i.e., those on the “lower” side of the car in FIG. 8). The carriage 701 has cameras 706 and 707, the carriage 702 has cameras 708 and 709, and the carriage 703 has cameras 710 and 711. The cameras 706, 708, and 710 are positioned to have an imaging direction that matches the direction indicated by an arrow 714. The cameras 707, 709, and 711 are positioned to have an imaging direction that matches the direction indicated by an arrow 713.

Assume that there are a train driver (not shown) in the driver's cab 704, a conductor (not shown) in the driver's cab 705 and that both the train driver and the conductor monitor the platform 712. The train driver looks in the direction indicated by the arrow 714 to check the platform 712. Accordingly, the train driver can preferably view the images captured by the cameras 706, 708, and 710 which have an imaging direction that matches the direction indicated by the arrow 714. In contrast, the conductor looks in the direction indicated by the arrow 713 to check the platform 712. Accordingly, the conductor can preferably view the images captured by the cameras 707, 709, and 711 which have an imaging direction that matches the direction indicated by the arrow 713.

In other words, there are provided two groups of cameras having opposing imaging directions substantially along a straight line on the carriages. The display device 1 then selectively displays, as monitoring images for the user, those images captured with an imaging direction that matches the near-view-to-distant-view direction when viewed from the location of the user such as the train driver or the conductor.

This configuration enables a display to be produced that is suitable for monitoring by the user. If the displayed images are to be selected on the basis of the location of the user, the images can be displayed at positions suitable for the monitoring by, as described in Embodiment 1, displaying the images such that the near and distant views in the images appear contiguous.

FIG. 9 is a plan view of a portion of a train 800 in accordance with the present embodiment as the train 800 is viewed from above. FIG. 9 shows a portion of the train 800 and a station platform 811. The train 800 consists (primarily) of a set of coupled carriages 801, 802, and 803. The carriage 802 has a crew's cabin 804. Each carriage is provided with cameras. FIG. 9 shows only those cameras that are located on one of the sides of the car (i.e., those on the “lower” side of the car in FIG. 9). The carriage 801 has cameras 805 and 806, the carriage 802 has cameras 807 and 808, and the carriage 803 has cameras 809 and 810. The cameras 805, 807, and 809 are positioned to have an imaging direction that matches the direction indicated by an arrow 813. The cameras 806, 808, and 810 are positioned to have an imaging direction that matches the direction indicated by an arrow 812.

Assume that there is a conductor (not shown) in the crew's cabin 804 and that the conductor monitors the platform 811. The conductor monitors the platform 811 from the crew's cabin 804 (the location of the conductor). Accordingly, when the conductor looks in the direction indicated by the arrow 812 to monitor the left-hand side of the crew's cabin 804 (i.e., to monitor the platform 811 in the direction indicated by the arrow 812), the conductor can preferably view the image captured by the camera 806 which has an imaging direction that matches the direction indicated by the arrow 812. In contrast, when the conductor looks in the direction indicated by the arrow 813 to monitor the right-hand side of the crew's cabin 804 (i.e., to monitor the platform 811 in the direction indicated by the arrow 813), the conductor can preferably view the images captured by the cameras 807 and 809 which have an imaging direction that matches the direction indicated by the arrow 813.

### Advantages of Embodiment 2

As described in the above, a display can be produced that is suitable for monitoring by the user by selectively displaying, as monitoring images for the user, those images captured with an imaging direction that matches the near-view-to-distant-view direction when viewed from the location of the user such as the conductor. In addition, when the user such as the conductor is somewhere between the front and the end of the train, a display can be produced that is suitable for the monitoring of both the forward direction and the backward direction by displaying, as monitoring images for the user, those images captured with an imaging direction that matches the near-view-to-distant-view direction when viewed from the location of the user, regardless of whether the user is looking in the forward direction or the backward direction as viewed from the location. If a plurality of images is to be displayed regardless of whether the user is either in the front or end of the train or somewhere between the front and end of the train, the images can be displayed at positions suitable for the monitoring by displaying the images such that the near and distant views in the images appear contiguous regardless of whether the user is looking in the forward direction or the backward direction.

### Embodiment 3

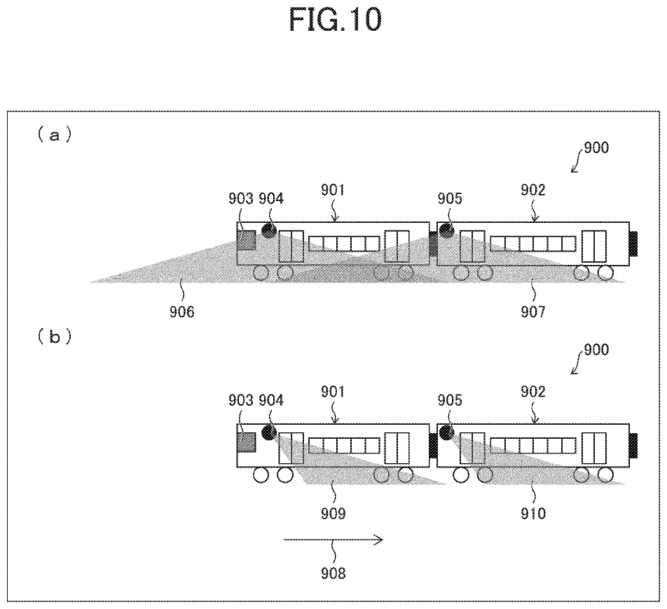

A detailed description will be given next of a display device 1 in accordance with Embodiment 3 of the present invention with reference to FIG. 10. The present embodiment cuts out portions of images captured by the cameras installed on carriages, to display the cut-out portions.

Portion (a) of FIG. 10 is a side view of a train 900 in accordance with the present embodiment as the train 900 is viewed from a side thereof. The train 900 consists (primarily) of a set of coupled carriages 901 and 902. The carriage 901 has a driver's cab 903. The carriage 901 has a camera 904, and the carriage 902 has a camera 905. Portion (a) of FIG. 10 shows an imaging range 906 of the camera 904 and an imaging range 907 of the camera 905. Referring to (a) of FIG. 10, the cameras 904 and 905 may be cameras with a wide angle of view such as cameras with a fisheye lens and may be cameras with a lens capable of imaging both the forward and backward directions.

A camera with a wide angle of view will capture an image covering large areas including and beyond the station platform to be monitored. Consequently, the captured image contains areas that do not need to be monitored by the user. Accordingly, in the present embodiment, the display device 1 cuts out portions of captured images to display images suitable for monitoring.

Specifically, the cameras 904 and 905 have an imaging range that includes the forward and backward directions with respect to the train 100. In accordance with this configuration, if there is installed a camera on a carriage located forward of the carriage where the display device 1 is installed, the image processing unit 11 extracts portions corresponding to the forward direction with respect to the train 100 from the images captured by the cameras installed on the carriage located forward (from the images captured with an angle of view covering the front-back direction with respect to the train 100). If there is installed a camera on a carriage located backward the carriage where the display device 1 is installed, the image processing unit 11 extracts portions corresponding to the backward direction with respect to the train 100 from the images captured by the cameras installed on the carriage located backward (from the images captured with an angle of view covering the front-back direction with respect to the train 100). The image processing unit 11 generates a display image on the basis of the extracted portions of the images.

The display device 1 cuts out images containing an area to be monitored from captured images in such a manner that the cut-out images share the same near-view-to-distant-view direction and displays the cut-out images such that the near and distant views in the images appear contiguous.

In other words, when the display image is to include a plurality of images, the image processing unit 11 arranges the images in such a manner that the carriages where the cameras capturing the images are installed appear lined up along a specific direction in the approaching order when viewed from the carriage where the display device 1 is installed. The specific direction is parallel to the direction from the distant view to the near view in each image.

Portion (b) of FIG. 10 is a side view of the train 900 in accordance with the present embodiment as the train 900 is viewed from a side thereof, similarly to (a) of FIG. 10. Portion (b) of FIG. 10 shows a display area 909 cut out, from the imaging range 906 of the camera 904 and a display area 910 cut out from the imaging range 907 of the camera 905. The display area 909 and the display area 910 cover the same direction. Accordingly, the display device 1 displays the display area 909 and the display area 910 by arranging the display area 909 and the display area 910 in such a manner that the near and distant views in the images appear contiguous.

When portions are cut out from wide-angle-of-view images shown in (a) of FIG. 10 for display, the display device 1 similarly produces a display by taking the location of the user into account. This configuration produces a more suitable display for monitoring by the user. In (b) of FIG. 10, a train driver (not shown) in the driver's cab 903 monitors in the direction indicated by an arrow 908. Accordingly, the display device 1 cuts out portions of the wide-angle-of-view images in such a manner that the near-view-to-distant-view direction in the portions of the images matches the direction indicated by the arrow 908.

### Advantages of Embodiment 3

As described in the above, the display device 1 is capable of producing a suitable display for monitoring by the user by arranging and displaying a plurality of cut-out display areas in such a manner that the near and distant views in the images appear contiguous. The display device 1 is also capable of producing a suitable display for monitoring by the user by cutting out portions of wide-angle-of-view captured images in such a manner that the near-view-to-distant-view direction in the portions of the images matches the direction in which the user monitors the platform, because the direction in which the user visually checks the platform matches the near-view-to-distant-view direction in the cut-out portions of the images.

Embodiment 4

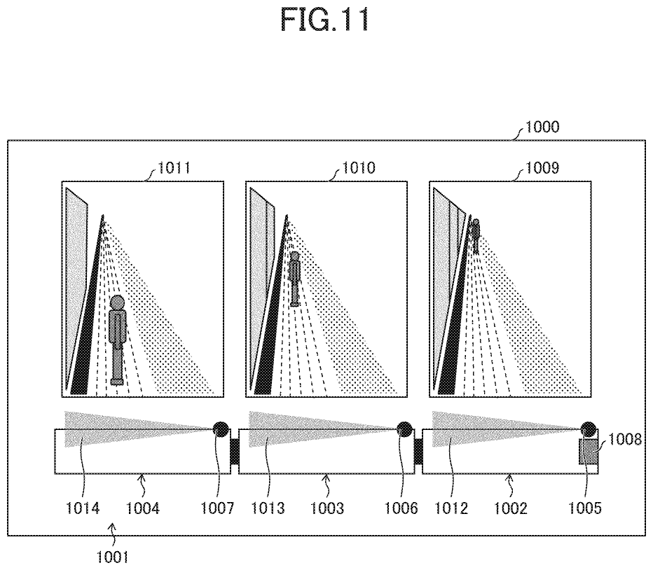

A detailed description will be given next of a display device 1 in accordance with Embodiment 4 of the present invention with reference to FIGS. 11 to 13. The present embodiment displays a captured image and an overhead view of a vicinity of the carriage next to each other to produce a more suitable display for monitoring.

FIG. 11 illustrates a display screen 1000 of the display device 1 in accordance with the present embodiment. The display device 1 displays an overhead view of a train 1001 on the display screen 1000 as the train 1001 is viewed from above. The train 1001 consists (primarily) of a set of coupled carriages 1002, 1003, and 1004. The carriage 1002 has a driver's cab 1008. The carriage 1002 has a camera 1005, the carriage 1003 has a camera 1006, and the carriage 1004 has a camera 1007. All the cameras are positioned to point and capture images in the left-hand side of FIG. 11.

The display device 1 displays an image 1009 captured by the camera 1005, an image 1010 captured by the camera 1006, and an image 1011 captured by the camera 1007 on the display screen 1000. The display device 1 then displays the image 1009 above the carriage 1002, the image 1010 above the carriage 1003, and the image 1011 above the carriage 1004. Thus, the display device 1 produces a display in which the positions of the carriages and cameras are associated with the positions of the images captured by the cameras.

The display method illustrated in FIG. 11 not only associates the relative positions of the carriages, cameras, and images, but also gives the same near-view-to-distant-view direction for the three images in such a manner that near and distant views in the images appear contiguous. Owing to these features, the display method produces a suitable display for monitoring by the user. The display method illustrated in FIG. 11 is also suitable for recognizing the left and right sides of the train.

The captured images 1009, 1010, and 1011 are all captured by cameras installed on the left side of the train 1001 (the left side of the carriages assuming that the cars move to the right in FIG. 11). Since the captured images 1009, 1010, and 1011 are displayed to the left of the train 1001 (in the top of FIG. 11) on the display screen 1000, the left-right positions in the captured images with respect to the carriages match the display positions of the images with respect, to the overhead view of the carriages. Therefore, the user can easily recognize the left-right positions in the displayed image. One should monitor boarding and alighting passengers on different sides of the carriages, depending on stations. This display, which enables the user to easily recognize which side of the carriages is being displayed, is suitable for monitoring by the user.

In addition, the display screen 1000 displays an imaging range 1012 of the camera 1005, an imaging range 1013 of the camera 1006, and an imaging range 1014 of the camera 1007 superimposed on the overhead view of the respective carriages. The user can hence easily recognize which part of the vicinity of the car is being represented by each of the captured images 1009, 1010, and 1011. A description will be given next of a display method used when one should monitor different (left and right) sides of the carriages. Portion (a) of FIG. 12 illustrates a display image 1100 for monitoring the left side of carriages in accordance with the present embodiment when the train is moving to the right in the figure. Meanwhile, portion (b) of FIG. 12 illustrates a display image 1101 for monitoring the right side of the carriages in accordance with the present embodiment when the train is moving to the right in the figure. In (a) of FIG. 12, captured images are displayed in the top, and an overhead view of a train is displayed in the bottom. In other words, captured images are displayed on the monitored side (the left side of the carriages). Meanwhile, in (b) of FIG. 12, captured images are displayed in the bottom, and an overhead view of the train is displayed on the top. In other words, captured images are displayed on the monitored side (the right side of the carriages). The display positions of the captured images and the overhead view of the train are switched in accordance with the monitored side of the train, as shown in (a) and (b) of FIG. 12.

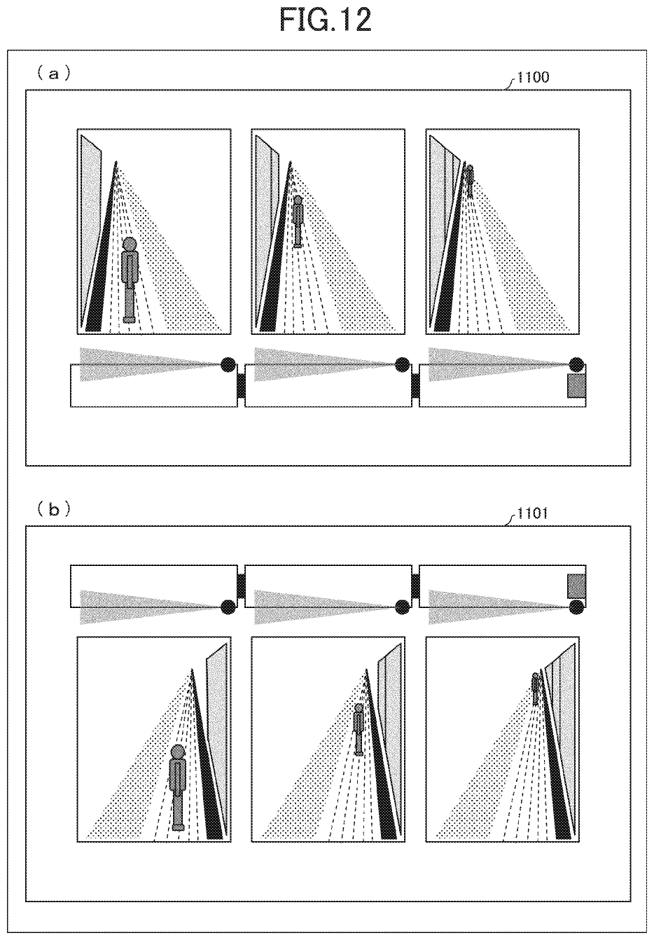

Portion (a) of FIG. 13 illustrates an overhead view of a train and camera-captured images being displayed on a display screen 1200 in accordance with the present embodiment. Portion (b) of FIG. 13 illustrates an overhead view of a train and camera-captured images being displayed on a display screen 1201 in accordance with the present embodiment.

Refilling to (a) and (b) of FIG. 13, the overhead view of the train is displayed in the same position on the display screen 1200 and on the display screen 1201. In other words, when the display screen 1200 and the display screen 1201 are compared, the position of the overhead view of the train is not changed on the display device 1, whereas the display position of the captured images is changed on the display device 1 in accordance with which of the left and right sides of the carriages should be monitored.

### Advantages of Embodiment 4

As described in the above, the display device 1 is capable of producing a suitable display for monitoring by the user by associating the positions of the carriages and cameras with the positions of the images captured by the cameras in such a manner that the user can easily recognize which part of the train is represented by each display image. The display device 1 is suitably capable of producing such a display that the user can easily recognize the left-right positions since the display device 1 always displays captured images on the side of the overhead view of the carriages to be monitored, by switching the display position of the overhead view of the train and the display position of the captured images in accordance with which side of the train is to be monitored. The display device 1 is capable of producing a suitable display for monitoring by the user by changing the display position of captured images in accordance with which of the left and right sides of the carriages should be monitored in such a manner that the user can easily recognize the left-right positions with respect to the carriages.

### Embodiment 5

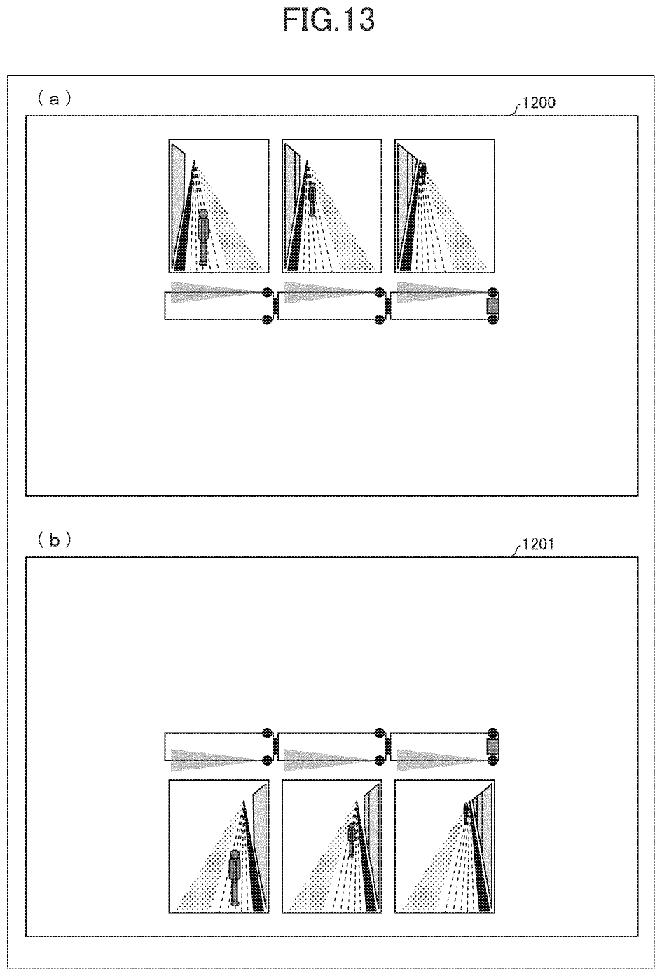

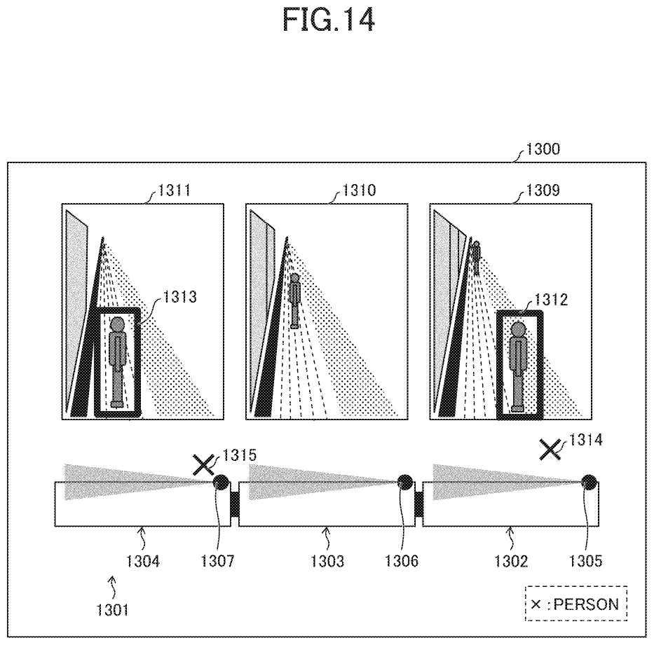

A detailed description will be given next of a display device 1 in accordance with Embodiment 5 of the present invention with reference to 14. FIG. 14 illustrates an overhead view of a train and camera-captured images being displayed on a display screen 1300 in accordance with the present embodiment.

The display device 1 displays on the display screen 1300 an overhead view of a train 1301 as the train 1301 is viewed from above as shown in FIG. 14. The train 1301 consists (primarily) of a set of coupled carriages 1302, 1303, and 1304. The carriage 1302 has a camera 1305, the carriage 1303 has a camera 1306, and the carriage 1304 has a camera 1307. All the cameras are positioned to point and capture images in the left-hand side of FIG. 14.

The display device 1 displays an image 1309 captured by the camera 1305, an image 1310 captured by the camera 1306, and an image 1311 captured by the camera 1307 on the display screen 1300. The display device 1 then displays the image 1309 above the carriage 1302, the image 1310 above the carriage 1303, and the image 1311 above the carriage 1304 on the display screen 1300.

The display device 1 displays over the image 1309 a detection frame 1312 that represents the detection of a person in the image 1309. The display device 1 further displays over the image 1311 a detection frame 1313 that represents the detection of a person in the image 1311. The display device 1 then displays in the overhead view of the train 1301 a detection point 1314 that represents the location corresponding to the detection frame 1312 and a detection point 1315 that represents the location corresponding to the detection frame 1313.

### Advantages of Embodiment 5

As described in the above, the display device 1 is capable of producing a suitable display for monitoring by the user by displaying the location of a person in an overhead view in such a manner that the user can easily recognize where the person shown in the image is on the station platform.

Embodiment 6

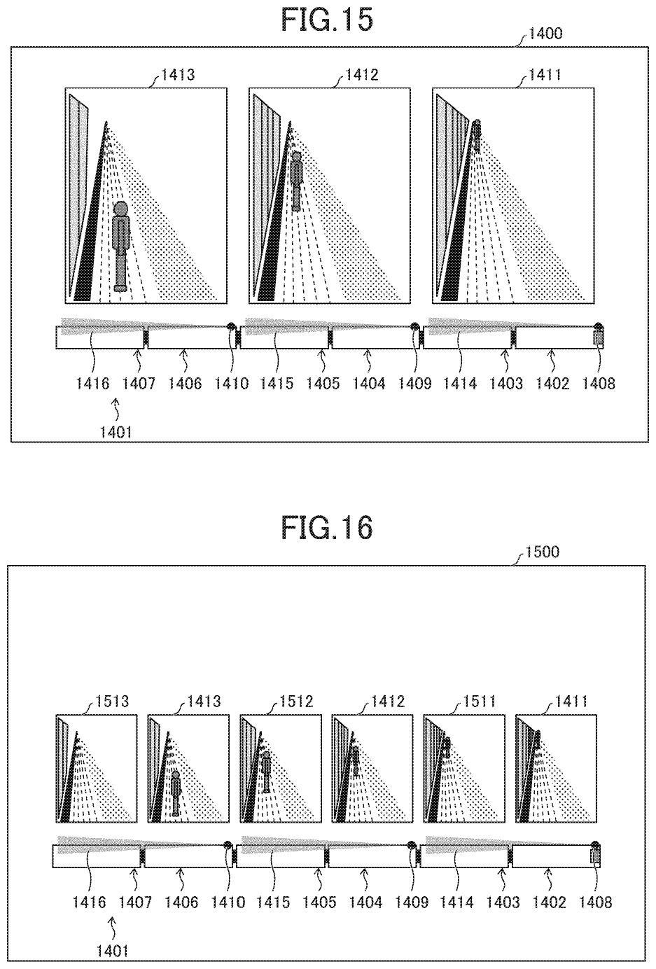

A detailed description will be given next of a display device 1 in accordance with Embodiment 6 of the present invention with reference to FIGS. 15 and 16.

FIG. 15 illustrates an overhead view of a train and camera-captured images being displayed on a display screen 1400 in accordance with the present embodiment.

The display device 1 displays on the display screen 1400 an overhead view of a train 1401 as the train 1401 is viewed from above as shown in FIG. 15. The train 1401 consists (primarily) of a set of coupled carriages 1402, 1403, 1404, 1405, 1406, and 1407. The carriage 1402 has a camera 1408, the carriage 1404 has a camera 1409, and the carriage 1406 has a camera 1410. All the cameras are positioned to point and capture images in the left-hand side of FIG. 15.

The display device 1 displays on the display screen 1400 an image 1411 captured by the camera 1408, an image 1412 captured by the camera 1409, and an image 1413 captured by the camera 1410. The display device 1 further displays an imaging range 1414 of the camera 1408, an imaging range 1415 of the camera 1409, and an imaging range 1416 of the camera 1410 in the overhead view of the train 1401.

Referring to FIG. 15, a carriage provided with a camera and a carriage provided with no camera are alternately coupled in the train 1401. The number of carriages does not match the number of cameras. However, the camera 1408 captures images on and near a side of the carriages 1402 and 1403, the camera 1409 captures images on and near a side of the carriages 1404 and 1405, and the camera 1410 captures images on and near a side of the carriages 1406 and 1407. One can therefore monitor an entire side of the train 1401 using the three cameras.

The cameras 1408, 1409, and 1410 are all located substantially along a straight line and pointed in such a direction as to share the same imaging direction, similarly to the configuration where each carriage has a camera. The display device 1 displays the images 1411, 1412, and 1413 in such a manner that the images 1411, 1412, and 1413 share the same near-view-to-distant-view direction and the near and distant views in the images appear contiguous. This configuration enables a display of a plurality of images in suitable locations for monitoring by the user. If the train 1401 includes a carriage that has no camera, a portion of an image captured by a camera installed on another carriage may be cut out for display.

FIG. 16 illustrates an overhead view of a train and camera-captured images being displayed on a display screen 1500 in accordance with the present embodiment. The composition of the train and the layout and imaging ranges of the cameras on the display screen 1500 are the same as those on the display screen 1400 in FIG. 15. The display screen 1500 differs from the display screen 1400 in how captured images are displayed.

Referring to FIG. 16, the display device 1 displays on the display screen 1500 an image 1511 obtained by cutting out a part of the captured image 1411 that corresponds to the carriage 1403, an image 1512 obtained by cutting out a part of the captured image 1412 that corresponds to the carriage 1405, and an image 1513 obtained by cutting out a part of the captured image 1413 that corresponds to the carriage 1407, as well as the images 1411, 1412, and 1413 captured by the cameras 1408, 1409, and 1410. The display device 1 may scale up the images 1511, 1512, and 1513 approximately to the size of the captured images 1411, 1412, and 1413 before displaying them as shown in FIG. 16.

### Advantages of Embodiment 6

As described in the above, the display device 1 is capable of displaying images in suitable locations for monitoring by the user even when there is a carriage that has no camera. The display device 1 is also capable of producing a suitable display for monitoring by the user by cutting out and displaying an image corresponding to a carriage that has no camera in such a manner that an image is displayed for each carriage, which helps the user recognize the relationship between the imaging ranges for the images and the locations of the carriages.

### General Description

The present invention, in aspect 1 thereof, is directed to a display device (1) installed on a train (100) including a plurality of carriages on at least one of which an imaging device (camera 106) is installed, the display device including: an image processing unit (11) configured to generate a display image based on an image captured by the imaging device and on relative positions of the carriage on which the imaging device is installed and a carriage on which the display device is installed; and a display unit (12) configured to display the display image generated by the image processing unit.

According to this structure and configuration, the display image is generated and displayed based on the images captured by the imaging devices and on the relative positions of the carriages on which the imaging devices are installed and the carriage on which the display device is installed. A display of the train and a vicinity thereof can be hence produced in a manner suitable for monitoring.

In aspect 2 of the present invention, the display device of aspect 1 may be configured such that the imaging device includes an imaging device with an imaging range covering a forward direction with respect to the train and an imaging device with an imaging range covering a backward direction with respect to the train, and the image processing unit, if the imaging device is installed on a carriage located forward of the carriage on which the display device is installed, selects an image captured by the imaging device installed on the carriage located forward, the selected image being captured by the imaging device with an imaging range covering the forward direction, and if the imaging device is installed on a carriage located backward of the carriage on which the display device is installed, selects an image captured by the imaging device installed on the carriage located backward, the selected image being captured by the imaging device with an imaging range covering the backward direction, and generates the display image based on the selected image.

According to this structure and configuration, if there is an imaging device installed on a carriage located either forward or backward of the carriage on which the display device is installed, an image captured by the imaging device with an imaging range covering that direction is selected for display from the images captured by the imaging device installed on the carriage located in the direction. A display of the train and a vicinity thereof can be hence produced in a manner suitable for monitoring.

In aspect 3 of the present invention, the display device of aspect 1 may be configured such that the imaging device has an imaging range covering a forward direction and a backward direction with respect to the train, and the image processing unit, if the imaging device is installed on a carriage located forward of the carriage on which the display device is installed, extracts a range corresponding to the forward direction with respect to the train from an image captured by the imaging device installed on the carriage located forward, and if the imaging device is installed on a carriage located backward of the carriage on which the display device is installed, extracts a range corresponding to the backward direction with respect to the train from an image captured by the imaging device installed on the carriage located backward, and generates the display image based on the extracted range of the image.

According to this structure and configuration, if there is an imaging device installed on a carriage located either forward or backward of the carriage on which the display device is installed, a range corresponding to that direction with respect to the train is extracted for display from the image captured by the imaging device installed on the carriage located in the direction. A display of the train and a vicinity thereof can be hence produced in a manner suitable for monitoring.

In aspect 4 of the present invention, the display device of aspect 1 may be configured such that the image processing unit, if the imaging device is installed on a carriage located forward of the carriage on which the display device is installed, controls the imaging device installed on the carriage located forward to have an imaging range covering the forward direction with respect to the train, and if the imaging device is installed on a carriage located backward of the carriage on which the display device is installed, controls the imaging device installed on the carriage located backward to have an imaging range covering the backward direction with respect to the train, and generates the display image based on an image captured by the controlled imaging device.

According to this structure and configuration, if there is an imaging device installed on a carriage located either forward or backward of the carriage on which the display device is installed, the imaging device installed on the carriage located in that direction is controlled to have an imaging range covering the direction with respect to the train in producing a display. A display of the train and a vicinity thereof can be hence produced in a manner suitable for monitoring.

In aspect 5 of the present invention, the display device of any one of aspects 1 to 4 may be configured such that the image processing unit arranges a plurality of images in the display image in such a manner that carriages on which imaging devices capturing the images are installed appear lined up along a specific direction in an approaching order when viewed from the carriage on which the display device is installed, and the specific direction is parallel to a direction from a distant view to a near view in each image.

According to this structure and configuration, the image processing unit arranges a plurality of images in the display image in such a manner that carriages on which imaging devices capturing the images are installed appear lined up along a specific direction in an approaching order when viewed from the carriage on which the display device is installed, and the specific direction is parallel to a direction from a distant view to a near view in each image. A display of the train and a vicinity thereof can be hence produced in a manner suitable for monitoring.

The present invention, in aspect 6 thereof, is directed to an imaging and display system (display system 50) including: the display device of any one of aspects 1 to 5; and the imaging device.

The present invention, in aspect 7 thereof, is directed to a train including: the display device of any one of aspects 1 to 5; and the imaging device.

The present invention is not limited to the description of the embodiments above and may be altered within the scope of the claims. Embodiments based on a proper combination of technical means disclosed in different embodiments are encompassed in the technical scope of the present invention. Furthermore, new technological features can be created by combining different technological means disclosed in the embodiments.

1. A display device installed on a train including a plurality of carriages on at least one of which at least one imaging device is installed, the display device comprising:
one or more processors configured to cause the display device to function as an image processing circuitry, the image processing circuitry being configured to generate a display image based on at least one image captured by the at least one imaging device and on relative positions of the carriage on which the imaging device is installed and a carriage on which the display device is installed; and
a display configured to display the display image generated by the image processing circuitry.

2. The display device according to claim 1, wherein
the at least one imaging device includes a first imaging device with an imaging range covering a forward direction with respect to the train and a second imaging device with an imaging range covering a backward direction with respect to the train, and
the image processing circuitry,
if the at least one imaging device is installed on a carriage located forward of the carriage on which the display device is installed, selects an image captured by the at least one imaging device installed on the carriage located forward, the selected image being captured by the first imaging device with an imaging range covering the forward direction, and if the at least one imaging device is installed on a carriage located backward of the carriage on which the display device is installed, selects an image captured by the at least one imaging device installed on the carriage located backward, the selected image being captured by the second imaging device with an imaging range covering the backward direction, and
generates the display image based on the selected image.

3. The display device according to claim 1, wherein
the at least one imaging device has an imaging range covering a forward direction and a backward direction with respect to the train, and
the image processing circuitry,
if the at least one imaging device is installed on a carriage located forward of the carriage on which the display device is installed, extracts a range corresponding to the forward direction with respect to the train from an image captured by the at least one imaging device installed on the carriage located forward, and if the at least one imaging device is installed on a carriage located backward of the carriage on which the display device is installed, extracts a range corresponding to the backward direction with respect to the train from an image captured by the at least one imaging device installed on the carriage located backward, and
generates the display image based on the extracted range of the image.

4. The display device according to claim 1, wherein
the image processing circuitry,
if the at least one imaging device is installed on a carriage located forward of the carriage on which the display device is installed, controls the at least one imaging device installed on the carriage located forward to have an imaging range covering the forward direction with respect to the train, and if the at least one imaging device is installed on a carriage located backward of the carriage on which the display device is installed, controls the at least one imaging device installed on the carriage located backward to have an imaging range covering the backward direction with respect to the train, and
generates the display image based on an image captured by the controlled imaging device.

5. The display device according to claim 1, wherein
the image processing circuitry arranges a plurality of images in the display image in such a manner that carriages on which imaging devices capturing the images are installed appear lined up along a specific direction in an approaching order when viewed from the carriage on which the display device is installed, and
the specific direction is parallel to a direction from a distant view to a near view in each image.

6. An imaging and display system comprising:
the display device according to claim 1; and
the at least one imaging device.

7. A train comprising:
the display device according to claim 1; and
the at least one imaging device.
